(19) United States
(12) Patent Application Publication
(10) Pub. No.: US 2004/0142225 A1
(43) Pub. Date: Jul. 22, 2004

(54) Fuel cell or electrolyser construction

(76) Inventors: Mark Christopher Turpin, Loughborough, Leicestershire (GB); James Charles Boff, Pinner, Middlesex (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/476,102

(22) PCT Filed: Apr. 18, 2002
(86) PCT No.: PCT/GB02/01771

(30) Foreign Application Priority Data
May 3, 2001 (GB) 0110913.1
May 3, 2001 (GB) 0110910.7
May 3, 2001 (GB) 0110911.5
May 3, 2001 (GB) 0110912.3
May 3, 2001 (GB) 0110915.6
Jun. 27, 2001 (GB) 0115711.4
Oct. 11, 2001 (GB) 0124448.2
Nov. 16, 2001 (GB) 0127525.4

(51) Int. Cl. H01M 8/02; C25B 9/00

(52) U.S. Cl. 429/38; 429/35; 204/277

(57) ABSTRACT

A fuel cell or electrolyser stack comprises countercurrent radially directed fuel and oxidant flow fields on either side of a membrane electrode assembly. A first reactant may flow radially outwardly from a manifold to a first reactant drain and a second reactant may flow inwardly from the edge of the assembly to a second reactant drain.

This invention relates to fuel cells and electrolysers, and is particularly, although not exclusively, applicable to proton exchange membrane fuel cells and electrolysers.

Fuel cells are devices in which a fuel and an oxidant combine in a controlled manner to produce electricity directly. By directly producing electricity without intermediate combustion and generation steps, the electrical efficiency of a fuel cell is higher than using the fuel in a traditional generator. This much is widely known. A fuel cell sounds simple and desirable but many man-years of work have been expended in recent years attempting to produce practical fuel cell systems. An electrolyser is effectively a fuel cell in reverse, in which electricity is used to split water into hydrogen and oxygen. Both fuel cells and electrolysers are likely to become important parts of the so-called “hydrogen economy”. In the following, reference is made to fuel cells, but it should be remembered that the same principles apply to electrolysers.

One type of fuel cell in commercial production is the so-called proton exchange membrane (PEM) fuel cell [sometimes called polymer electrolyte or solid polymer fuel cells (PEFCs)]. Such cells use hydrogen as a fuel and comprise an electrically insulating (but ionically conducting) polymer membrane having porous electrodes disposed on both faces. The membrane is typically a fluorosulphonate polymer and the electrodes typically comprise a noble metal catalyst dispersed on a carbonaceous powder substrate. This assembly of electrodes and membrane is often referred to as the membrane electrode assembly (MEA).

Fuel (typically hydrogen) is supplied to one electrode (the anode) where it is oxidised to release electrons to the anode and hydrogen ions to the electrolyte. Oxidant (typically air or oxygen) is supplied to the other electrode (the cathode) where electrons from the cathode combine with the oxygen and the hydrogen ions to produce water. A sub-class of proton exchange membrane fuel cell is the direct methanol fuel cell in which methanol is supplied as the fuel. This invention is intended to cover such fuel cells and indeed any other fuel cell using a proton exchange membrane.

In commercial PEM fuel cells many such membranes are stacked together separated by flow field plates (also referred to as bipolar plates). The flow field plates are typically formed of metal or graphite to permit good transfer of electrons between the anode of one membrane and the cathode of the adjacent membrane.

The flow field plates have a pattern of grooves on their surface to supply fluid (fuel or oxidant) and to remove water produced as a reaction product of the fuel cell. Various methods of producing the grooves have been described, for example it has been proposed to form such grooves by machining, embossing or moulding (WO00/41260), and by sandblasting through a resist (WO01/04982). In a sandblasting system, particles (such as sand, grit, fine beads, or frozen materials) are carried by a blast of air directed towards an article to be treated. The particles travel at a high speed, and on impacting the article abrade the surface.

To ensure that the fluids are dispersed evenly to their respective electrode surfaces a so-called gas diffusion layer (GDL) is placed between the electrode and the flow field plate. The gas diffusion layer is a porous material and typically comprises a carbon paper or cloth, often having a bonded layer of carbon powder on one face and coated with a hydrophobic material to promote water rejection.

The fuel and oxidant flow fields are typically of serpentine form, extending from a fluid inlet manifold to a fluid outlet manifold. Other flow field patterns can be used however. It has been an aim expressed in some disclosures (e.g. U.S. Pat. No. 5,773,160, U.S. Pat. No. 6,087,033, and US-A2001/0005557) to provide a counterflow arrangement in which the oxidant on one side of the membrane electrode assembly moves in the opposite direction to the fuel on the other side of the membrane electrode assembly. These arrangements do not provide a full counterflow of the fluid flows and provide an asymmetric distribution of pressures that can cause operational problems (as discussed below).

The applicants have realised that this problem can be overcome by providing radially divergent/convergent flow fields for the fuel and oxidant flow fields, in the sense that one flow field diverges outwardly and the other flow field converges inwardly. Accordingly, the present invention provides a fuel cell or electrolyser assembly having countercurrent radially directed fuel and oxidant flow fields on either side of a membrane electrode assembly.

Such an arrangement has further advantages in that the number of fluid connections can be reduced. In one advantageous arrangement, a first reactant gas flows outwardly from a manifold within the fuel cell stack to a first reactant drain and a second reactant gas flows inwardly from the edge of the flow field to a second reactant drain.

The invention is illustrated by way of example in the following description with reference to the drawings in which:

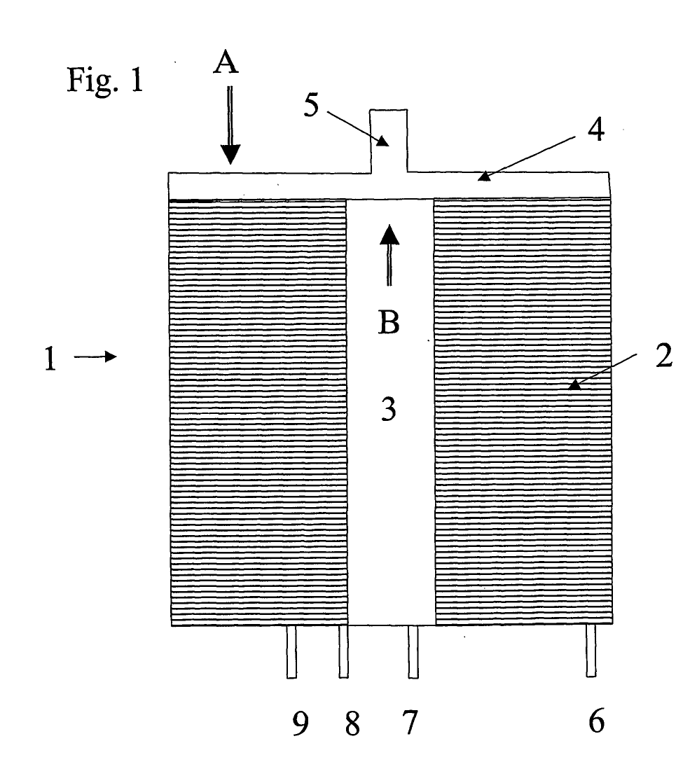

FIG. 1 shows schematically in part section a stack;

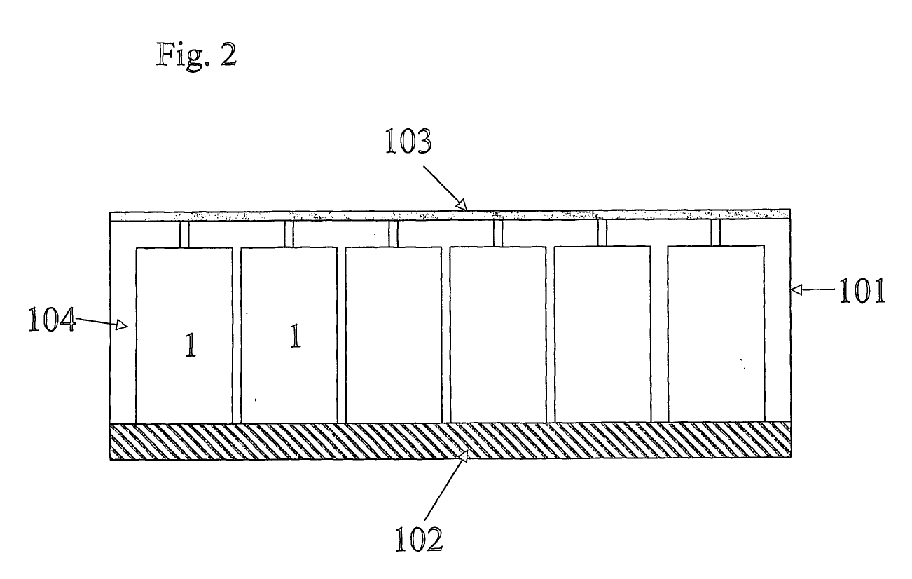

FIG. 2 shows schematically in side view a number of stacks according to FIG. 1 housed in a chamber;

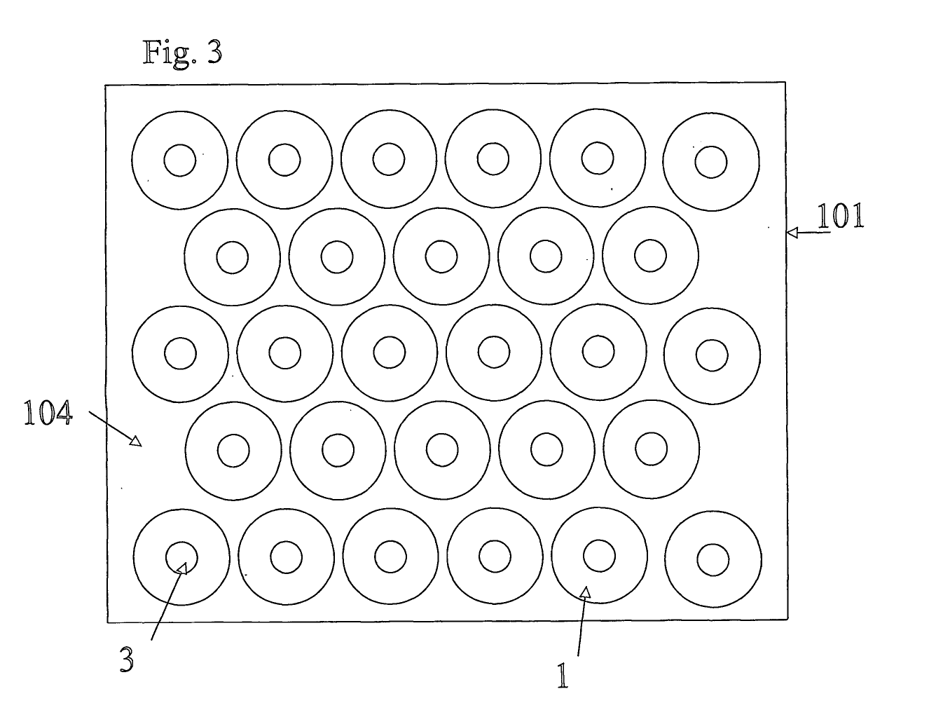

FIG. 3 shows schematically in plan a number of stacks according to FIG. 1 housed in a chamber;

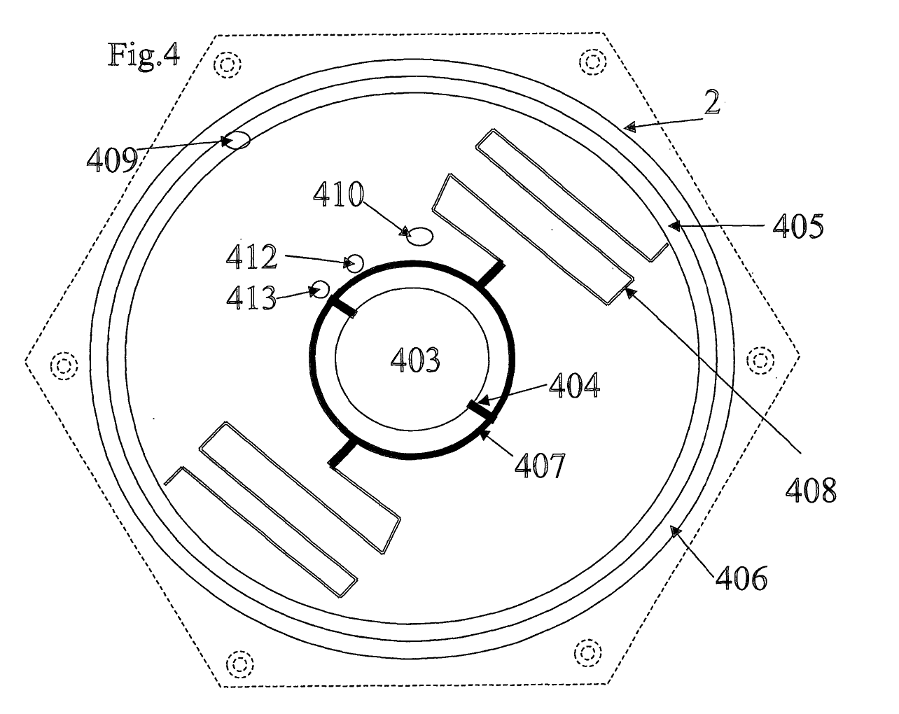

FIG. 4 shows schematically in top plan a fluid flow plate for use in accordance with the invention;

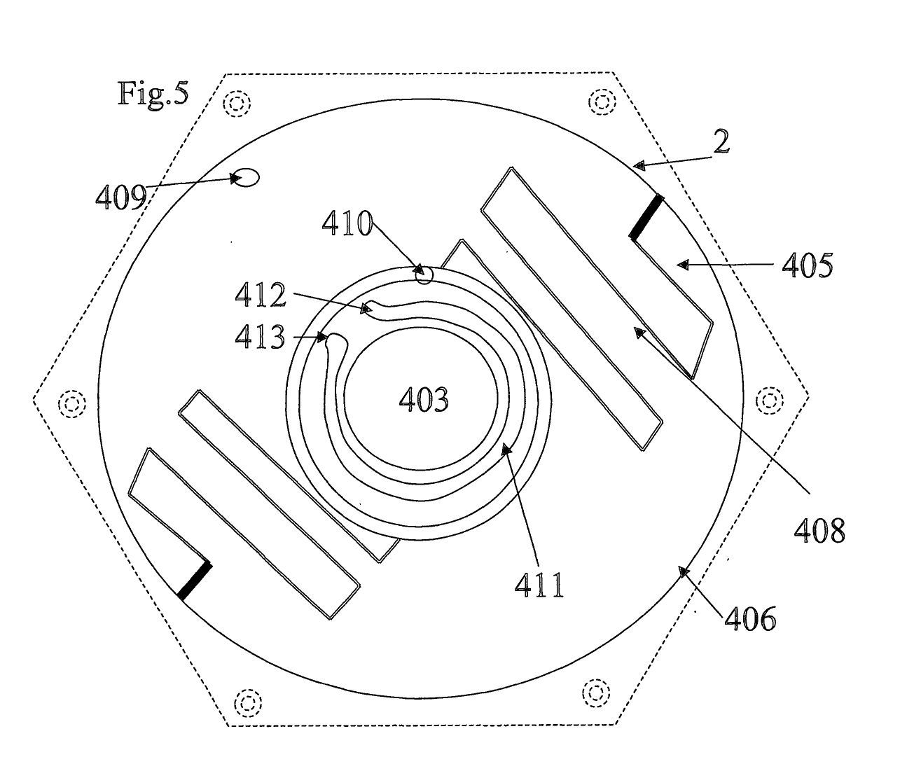

FIG. 5 shows in bottom plan the fluid flow plate of FIG. 4.

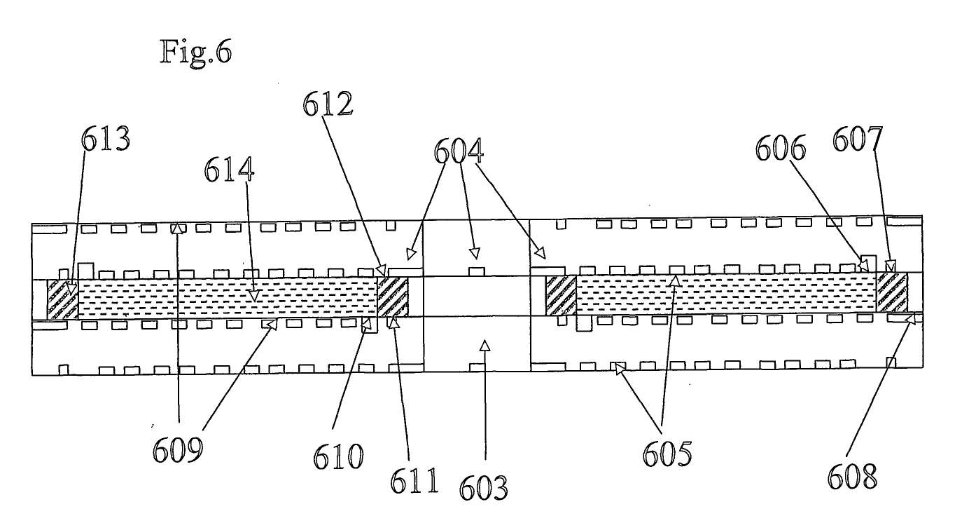

FIG. 6 shows schematically a pair of fluid flow plates incorporating a sealing mechanism in accordance with the invention;

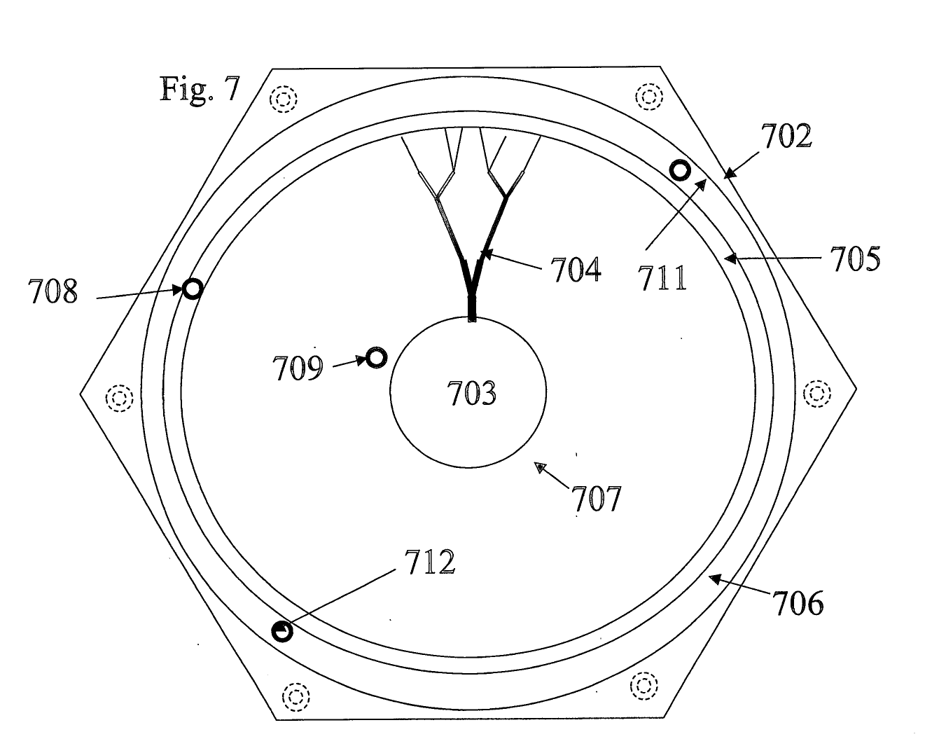

FIG. 7 shows an alternative form of flow field plate for use in accordance with the invention.

A stack 1 (FIG. 1) comprises a plurality of fluid flow plates 2. The fluid flow plates have aligned apertures 403 (FIGS. 4 & 5) forming a fuel supply aperture 3. One end of the stack is terminated by an end plate 4 comprising an electrical connector 5. The end plate 4 closes the end of the fuel supply aperture 3. The stack has connections serving as a fuel outlet 6; an oxidant outlet 7; a coolant inlet 8; and a coolant outlet 9.

Several of the stacks 1 are mounted in a chamber 101 having a system of manifolds 102 for connection to the fuel outlets 6, oxidant outlets 7; coolant inlets 8 and coolant outlets 9. The chamber 101 also has an electrical connection system 103 for connection to the stack electrical connectors 5. A corresponding electrical connection system forming part of the system of manifolds 102 connects to the base of each stack. The chamber 101 and the stacks 1 define between them a void space 104.

Flow field plate 2 is annular and, as stated above, has a central aperture 403. Fuel inlet 404 leads from the aperture 403 to a humidification section 407. From humidification section 407 a flow field 408 leads to a fuel drain 405. (Only part of the flow field is shown, several channels being provided extending radially outwardly from the humidification section). Aperture 409 passes through the flow field plate 1 and allows aligned apertures 409 in a stack to form an escape route for surplus fuel leading to fuel outlet 6.

Land 406 is configured to receive seals and this configuration may take place either with the formation of the flow field or in a separate step.

The oxidant flow field on the underside of flow field plate 2 is the reverse, with oxidant flowing radially inwardly from the outer edge of the flow field plate 402 to an inner drain 407 which connects with aperture 410. Aligned apertures 410 in a stack form an escape route for surplus oxidant leading to oxidant outlet 7. Coolant channel 411 runs from coolant inlet aperture 412 to coolant outlet aperture 413. Aligned coolant inlet apertures 412 in adjacent plates serve to receive coolant from coolant inlet 8 and aligned coolant outlet apertures 413 in adjacent plates serve to pass coolant to coolant outlet 9.

Coolant channel 411 is disposed to lie opposite humidification section 407 of the adjacent flow field plate. By placing a water permeable membrane between the coolant channel 411 and humidification channel 407 incoming hydrogen can be humidified. Sufficient humidification to prevent the membrane drying out is required.

A similar arrangement can be used to humidify incoming oxidant, using a coolant track on the fuel side of the opposed flow field plate. The need for humidification on the oxidant side is less than on the fuel side since water is produced on the oxidant side of the membrane electrode assembly. Some humidification of the oxidant is desirable (to prevent loss of water in the region where the oxidant enters the membrane) but too much humidification is undesirable, as this limits the water carrying capacity of the oxidant.

The water permeable membrane can by e.g. a thin film silicon rubber. The membrane of the membrane electrode assembly could be used in this role.

The pressure of oxidant in the void space 104 will serve to press down on the stack in the direction of arrow “A” in FIG. 1. The pressure of gas within the stack will press outwardly of the stack in the direction “B”, tending to separate the plates of the stack. The compressive force in the direction “A” will tend to counteract the pressure of gas in the direction “B”. Indeed, if the pressures and areas of application are chosen appropriately it is possible for the stack to be under compression. This principle can also be applied to a single stack in a chamber, as well as multiple stacks as exemplified.

Of course the whole arrangement can be reversed (oxidant up the middle and fuel at the outside) but for safety reasons the arrangement shown is preferred.

The arrangement described and illustrated is not limited to circular flow field plates, although. conventional flow field plates are rectangular in form which gives rise to problems with sealing at the corners. A circular or oval geometry for the seals may be advantageous. A circular arrangement is not ideal for aligning however, and as shown in FIGS. 4 and 5 a hexagonal plate could conveniently be used with fixing holes at the corners to receive threaded rods or other means for aligning or securing the stack. However, as the pressure of gas within the stack is at least partially compensated by the pressure outside the stack, relatively light securing means can be used.

The radial gas flow arrangement of FIGS. 4-6 is advantageous for several reasons. Firstly one has a countercurrent flow between the fuel and the oxidant which maintains a relatively even pressure differential across the membrane electrode compared with conventional bipolars, which tend to have a cross-flow arrangement. Such a relatively even pressure differential means that the membrane is under a relatively reduced stress. Secondly, the pressure is more evenly distributed across the width of the stack and this means that the forces acting on the bipolar plates are evenly distributed, lessening the risk of a plate breaking or deforming. Further, the evenness of pressure distribution leads to an improved uniformity of electricity generation across the membrane electrode.

FIG. 7 shows such a different form of radial countercurrent flow field bipolar, in which flow field plate 702 is hexagonal annular in form having a fuel supply aperture 703. Branching flow field pattern 704 (part shown) connects fuel supply aperture 703 to a fuel drain 705 which leads to fuel drainage port 708. Land 706 is configured to receive seals and this configuration may take place either with the formation of the flow field or in a separate step.

The oxidant flow field on the adjacent flow field plate is the reverse, with oxidant flowing in from the outer edge of the flow field plate to an inner drain communicating with oxidant drain port 709. On the reverse of the oxidant flow field plate is a coolant track. Coolant inlet port 711 communicates via this coolant track to coolant outlet port 712.

In this arrangement the fuel flow is divergent and the oxidant flow is convergent so providing a countercurrent radially directed fluid flow each side of the membrane electrode (using “radial” in the sense of moving towards or radiating from a point and not in the limited sense of referring to the radius of a circle). Preferred materials for the plate are graphite, carbon-carbon composites, or carbon-resin composites. However the invention is not restricted to these materials and may be used for any material of suitable physical characteristics.

The separate integers and combinations described above may form inventions in their own right.

1. A fuel cell or electrolyser assembly having countercurrent radially directed fuel and oxidant flow fields on either side of a membrane electrode assembly.

2. A filet cell or electrolyser assembly, as claimed in claim 1, in which a first reactant gas flows radially outwardly from a manifold to a first reactant drain and a second reactant gas flows inwardly from the edge of the assembly to a second reactant drain.

3. A filet cell or electrolyser assembly, as claimed in claim 1 or claim 2, in which incoming gas on a flow field plate urges a sealing ring towards a sealing groove on an adjacent flow field plate maintained at relatively low pressure with respect to the incoming gas.
